(19) United States
(12) Patent Application Publication
(10) Pub. No.: US 2013/0050267 A1
(43) Pub. Date: Feb. 28, 2013

(54) INFORMATION PROCESSING TERMINAL, DISPLAY CONTROL METHOD, AND DISPLAY CONTROL PROGRAM

(71) Applicants: Yuichiro Miyamoto, Osaka (JP); Toru Utsuki, Osaka (JP)

(72) Inventors: Yuichiro Miyamoto, Osaka (JP); Toru Utsuki, Osaka (JP)

(73) Assignee: PANASONIC CORPORATION, Osaka (JP)

(21) Appl. No.: 13/509,827

(22) PCT Filed: Sep. 29, 2011
(86) PCT No.: PCT/JP2011/005514

§ 371 Date: May 15, 2012

(30) Foreign Application Priority Data
Aug. 31, 2011 (JP) PCT/JP2011/004883

(51) Int. Cl. G09G 5/00

(52) U.S. Cl. 345/660; 345/619

(57) ABSTRACT

An information processing terminal (100) is capable of displaying contents that are supplied as print on paper and provided electronically as well. The information processing terminal (100) includes a display (114), a touch sensor (112) for detecting an input from a user on the display (114), and a control unit (140) for displaying the contents on the display (114). The control unit (140) switches between a first display mode for displaying list information of the contents on the display (114) and a second display mode for displaying the contents on the display (114) in the same layout as a layout of the print on paper in accordance with an instruction from the user.

### TECHNICAL FIELD

The present invention relates to an information processing terminal capable of displaying article contents that are supplied as print on paper and provided electronically as well.

### BACKGROUND ART

In recent years, information processing terminals capable of displaying electronic articles and other similar contents on a screen have been gaining popularity. Patent Document No. 1, for example, discloses a cellular phone that can display on a display unit a body text of one of a plurality of electronic articles. This cellular phone has a button for displaying electronic articles preceding and following the currently displayed article and displays the dates of the preceding and following electronic articles in the vicinity of the button. Pressing the button displays the preceding and following articles that are in the same category as that of the currently displayed article.

Patent Document No. 2 discloses displaying a plurality of pieces of information including category information on a terminal's screen so that a user can easily find a desired article from among distributed news articles. The user can specify a desired category to have the terminal display articles in the specified category.

Patent Document No. 3 discloses a display device capable of displaying, instead of electronic articles, a program listing sorted by time, channel, and category. A user can select a desired category from a plurality of categories to have the display device display a program listing in the selected category. This allows a user to search for objective program information intuitively.

Patent Documents No. 4 to No. 9 disclose devices capable of displaying news article contents on a screen. Those devices can display not only the details of each article but also a newspaper page image.

### CITATION LIST

### Patent Literature

Patent Document No. 1: Japanese Patent Application Laid-Open Publication No. 2009-15506
Patent Document No. 2: Japanese Patent Application Laid-Open Publication No. 2002-215732
Patent Document No. 3: Japanese Patent Application Laid-Open Publication No. 10-191193
Patent Document No. 4: Japanese Patent Application Laid-Open Publication No. 2010-250570
Patent Document No. 5: Japanese Patent Application Laid-Open Publication No. 2010-205252
Patent Document No. 6: Japanese Patent Application Laid-Open Publication No. 2003-132071
Patent Document No. 7: Japanese Patent Application Laid-Open Publication No. 2011-44013
Patent Document No. 8: Japanese Patent Application Laid-Open Publication No. 2002-236701
Patent Document No. 9: Japanese Patent Application Laid-Open Publication No. 2004-139399

### SUMMARY OF INVENTION

### Technical Problem

Conventional information processing terminals are supposed to display only one of a screen for displaying a newspaper page image and a screen for displaying a list of articles that are considered important by the publisher of the newspaper. The conventional terminals therefore cannot deal with the case where the preferred screen display mode varies from one user to another and the case where the same user wishes to switch to a different screen display mode that suits the situation. This problem is not limited to newspaper display but is common to the case where the displayed contents are magazines, general books, and the like.

The present invention has been made in view of the problem described above, and provides an information processing terminal capable of readily switching between a screen for displaying a list of articles that are considered to be important by the creator of contents and a screen for displaying contents in the same layout as that of print on paper.

### Solution to Problem

An information processing terminal according to the present invention displays contents that are supplied as print on paper and provided electronically as well. The information processing terminal includes a display, a touch sensor that detects an input from a user on the display, and a control unit that displays the contents on the display. The control unit switches between a first display mode for displaying list information of the contents on the display and a second display mode for displaying the contents on the display in the same layout as a layout of the print on paper in accordance with an instruction from the user.

In an embodiment, in the information processing terminal according to claim 1, the contents are newspaper articles.

In an embodiment, the control unit selects a portion of the contents displayed in the second display mode and displays the portion in the first display mode as well on the display.

In an embodiment, the portion of the contents is an image that represents a headline of an article or a photograph.

In an embodiment, the control unit displays a first button for switching to the second display mode on the display in the first display mode, displays a second button for switching to the first display mode on the display in the second display mode and, when the user taps the first button or the second button, switches between the first display mode and the second display mode.

In an embodiment, in the first display mode, the contents are sorted by date information and category information, and, when the user specifies a particular article displayed on the display in the second display mode, the control unit switches to the first display mode to display list information of a date and a category to which the particular article belongs on the display.

In an embodiment, when the user specifies a particular article in the first display mode, the control unit switches to a third display mode for displaying details information of the particular article on the display.

In an embodiment, when the user specifies a particular article displayed on the display in the second display mode, the control unit switches to a third display mode for displaying details information of the particular article on the display.

In an embodiment, in the third display mode, the control unit displays a third button for switching to the second display mode on the display and, when the user taps the third button, switches to the second display mode.

In an embodiment, when the user performs pinching in the second display mode, the control unit increases or reduces display magnification.

In an embodiment, when the user performs dragging in the second display mode, the control unit scrolls display.

In an embodiment, in the first display mode, the contents are sorted by date information and category information, and, in the first display mode, the control unit displays on the display the date information including a plurality of dates, the category information including a plurality of categories, and list information about a list of contents belonging to a date and a category that are selected by the user from among the plurality of dates of the date information and the plurality of categories of the category information.

In an embodiment, when a date different from a date of currently displayed contents is selected in the first display mode, the control unit displays, on the display, list information about a list of contents of the selected date that belong to the same category as a category of the currently displayed contents or a category similar to the category of the currently displayed contents.

In an embodiment, when a category different from a category of currently displayed contents is selected in the first display mode, the control unit displays, on the display, list information about a list of contents of the selected category that belong to the same date as a date of the currently displayed contents.

Another information processing terminal according to the present invention includes a display, a touch sensor that detects an input from a user on the display, a memory, a processor, and a program stored in the memory. The program controls the processor to execute the steps of: displaying list information of the contents on the display; displaying the contents on the display in the same layout as a layout of the print on paper; and switching between a first display mode for displaying the list information of the contents on the display and a second display mode for displaying the contents on the display in the same layout as the layout of the print on paper in accordance with an instruction from the user.

A display control method according to the present invention is for use in an information processing terminal for displaying contents that are supplied as print on paper and provided electronically as well. The display control method includes the steps of: displaying list information of the contents on a display of the information processing terminal; displaying the contents on the display in the same layout as a layout of the print on paper; and switching between a first display mode for displaying the list information of the contents on the display and a second display mode for displaying the contents on the display in the same layout as the layout of the print on paper in accordance with an instruction from a user.

A display control program according to the present invention is for use in an information processing terminal for displaying contents that are supplied as print on paper and provided electronically as well. The display control program controls a computer to execute the steps of: displaying list information of the contents on a display of the information processing terminal; displaying the contents on the display in the same layout as a layout of the print on paper; and switching between a first display mode for displaying the list information of the contents on the display and a second display mode for displaying the contents on the display in the same layout as the layout of the print on paper in accordance with an instruction from a user.

### Advantageous Effects of Invention

According to the present invention, it is possible to readily switch between the screen for displaying the list of articles that are considered to be important by the creator of contents and the screen for displaying contents in the same layout as that of print on paper, and user's convenience is thus improved.

### BRIEF DESCRIPTION OF DRAWINGS

FIG. 1 is a diagram illustrating the exterior appearance of an information processing terminal according to an embodiment.

FIG. 2 is a block diagram illustrating a hardware configuration of the information processing terminal according to the embodiment.

FIG. 3 are diagrams illustrating screen configuration examples of the information processing terminal according to the embodiment.

FIG. 4 is a diagram illustrating an example of categories and groups.

FIG. 5 are diagrams illustrating an example of transition between screens.

FIG. 6 are diagrams illustrating an example of screen transition concerning a newspaper page image.

FIG. 7 are diagrams illustrating another example of screen transition concerning a newspaper page image.

FIG. 8A is a flow chart illustrating an example of an operation concerning the displaying of a newspaper page image.

FIG. 8B is a flow chart illustrating another example of the operation concerning the displaying of a newspaper page image.

FIG. 9 are diagrams illustrating how a part of a newspaper page image is displayed in an article list screen.

FIG. 10 is a diagram illustrating an example of a data structure for generating the article list screen.

FIG. 11 are diagrams illustrating an example of screen transition in a date changing operation.

FIG. 12 is a flow chart illustrating the processing flow of the date changing operation.

FIG. 13 are diagrams illustrating an example of screen transition concerning a switch between horizontal writing display and vertical writing display.

FIG. 14 are diagrams illustrating an example of display for alerting the fact that the screen cannot be scrolled further.

FIG. 15 is a diagram illustrating an example of information communication between the information processing terminal and a distribution server.

FIG. 16 is a diagram illustrating an example of the data structure of distributed contents.

### DESCRIPTION OF EMBODIMENTS

An information processing terminal according to an embodiment of the present invention is capable of displaying newspapers, magazines, general books, and other contents that are supplied as print on paper and provided electronically as well. In particular, the information processing terminal according to the embodiment of the present invention can switch between a mode for displaying list information of contents and a mode for displaying the contents in the same contents layout as that of print on paper, and can thus improve users' convenience.

The embodiment of the present invention is described below with reference to the accompanying drawings.

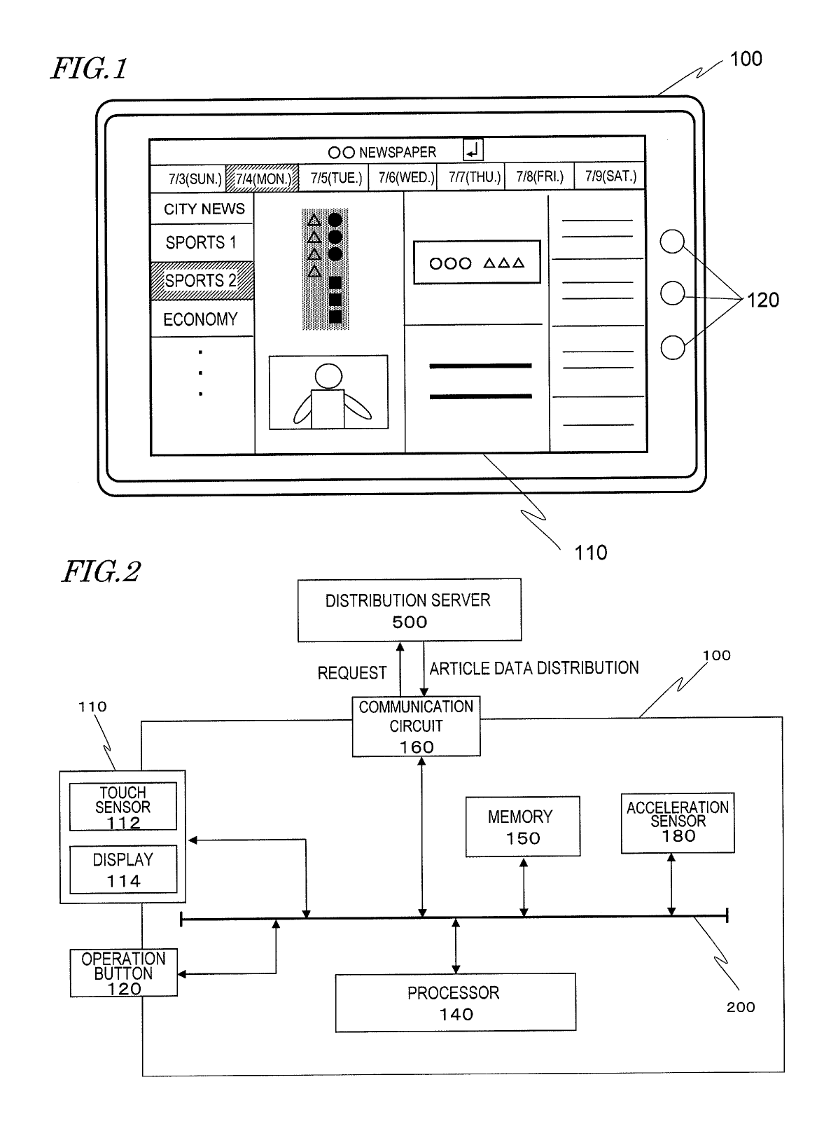

FIG. 1 is a diagram illustrating the exterior appearance of an information processing terminal 100 (hereinafter, sometimes referred to simply as “terminal”) according to this embodiment. The information processing terminal 100 of this embodiment is a terminal that has a function of displaying, on its display, data of newspaper articles distributed from a distribution server of a newspaper publishing company or the like.

The information processing terminal 100 includes a touch screen 110, which has a display for displaying contents and a touch sensor that detects an input from a user, and operation buttons 120, which make common operation of the information processing terminal 100 possible. The information processing terminal 100 may also include a power switch, an external IF, a camera, a speaker, a microphone, and others that are not particularly necessary for the understanding of the present invention and are therefore omitted from the description. The operation buttons 120 may be buttons that recognize an input by detecting the approach of a finger or the like with a touch sensor, or buttons that detect an input when actually pressed by the user.

FIG. 1 illustrates an example of a state in which newspaper article contents are displayed on the touch screen 110. The information processing terminal 100 may be a multi-purpose information processing terminal capable of, in addition to displaying electronic newspapers, viewing Web pages, viewing electronic books, sending and receiving e-mail, playing audio, taking photographs, and the like.

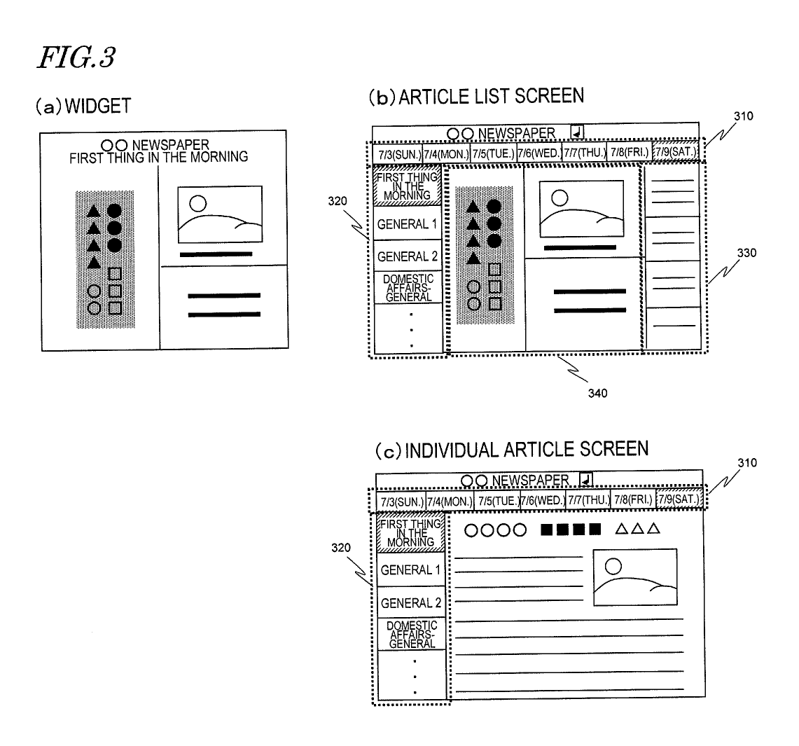

FIG. 2 is a block diagram illustrating a hardware configuration of the information processing terminal 100. FIG. 2 illustrates a distribution server 500 for distributing newspaper article data in addition to the information processing terminal 100. Other than the touch screen 110 and operation buttons 120 described above, the information processing terminal 100 includes a communication circuit 160 for holding wireless communication, a memory 150 for recording distributed article data and temporary data that is generated in the course of processing, an acceleration sensor 190 for detecting the direction of the information processing terminal 100, and a processor (control unit) 140 for controlling the operation of respective function units. The processor 140 is connected to the respective function units via a bus 200 to control the function units.

The touch screen 110 includes, as described above, the touch sensor which is denoted by 112 and detects an input from the user, and the display which is denoted by 114 and displays information. The touch screen 110 can be implemented by any known method as long as the method allows an input from the user and an output to the display.

The operation buttons 120 may be, as described above, buttons that detect an input with a touch sensor or buttons that detect an input when actually pressed by the user. The operation buttons 120 may include a button for calling up an initial screen (home screen) of the information processing terminal 100, a button for returning to the preceding screen display, a button for calling up a screen on which various settings of the terminal are made, and the like.

The processor 140 may be configured from, for example, a combination of an integrated circuit that includes a known central processing unit (CPU) and graphics processing unit (GPU) with various programs, or from dedicated hardware. The processor 140 controls what is displayed on the display 114 based on inputs from the operation buttons 120, the touch sensor 112, the communication circuit 160, the acceleration sensor 180, and others, and also controls communication to/from the distribution server 500.

The memory 150 is a known semiconductor memory such as a DRAM, an SRAM, or a flash memory. The memory 150 stores input data from the operation buttons 120, the touch sensor 112, the communication circuit 160, the acceleration sensor 180, and others, and various types of temporary data that are generated in processing of the processor 140. The memory 150 also stores various programs executed by the processor 140.

The communication circuit 160 is a known communication circuit for transmitting an article data request signal to the distribution server 500, which is provided on a site remote from the terminal, upon instruction from the processor 140, and for receiving distributed article data. The communication circuit 160 performs wireless communication in conformity to, for example, the IEEE 802.11 standards, and can connect to the Internet via a telephone line, an optical fiber network, a cellular phone network, or the like.

The acceleration sensor 180 is a sensor that detects the tilt of the information processing terminal 100. The processor 140 performs control for rotating what is displayed on the display 114 depending on the tilt detected by the acceleration sensor 180. Instead of the acceleration sensor 180, other types of sensors such as a gyroscope may be used to detect the tilt of the information processing terminal 100.

Examples of screen configurations used to display newspaper articles on the information processing terminal 100 are described below.

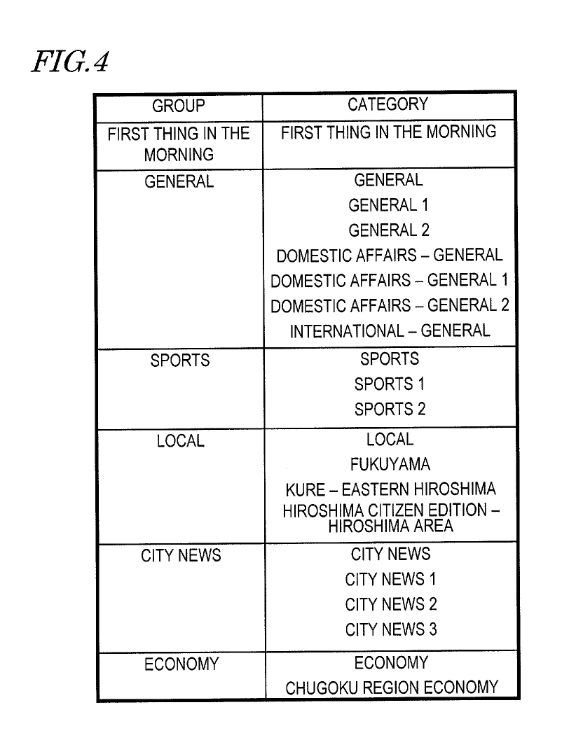

FIG. 3 are diagrams illustrating examples of screen configurations for displaying newspaper article contents on the information processing terminal 100. In this embodiment, screens prepared to display newspaper articles are roughly divided into a widget-based display screen and a dedicated application-based display screen.

FIG. 3(a) illustrates an example of the widget-based display screen. For example, the widget-based display screen may be displayed after the terminal is booted up based on settings customized in advance by the user. The widget-based display screen displays the headlines and photographs of main articles of the day by switching from, for example, page to page of a newspaper at regular time intervals. This allows the user to know summaries of newspaper articles of the day without activating a dedicated application. Though not shown in FIG. 3(a), the widget-based screen may display advertisement and extra news information in addition to article information.

FIGS. 3(b) and 3(c) illustrate examples of the dedicated application-based display screen. When an application activating icon displayed on the initial screen of the information processing terminal 100 is selected (tapped), or when one of article compartments displayed by the widget described above is tapped, a dedicated application is activated and one of the screens illustrated as examples in FIGS. 3(b) and 3(c) is displayed.

FIG. 3(b) illustrates an example of a screen that is displayed when the application activating icon is selected. This screen is for displaying a list of contents sorted by date information 310 and category information 320. This screen is prepared for each category, and takes the form of headlines or photographs, or a combination of headlines and photographs. The screen of FIG. 3(b) is hereinafter referred to as “article list screen”. In this embodiment, information displayed by the widget of FIG. 3(a) is the same as information displayed in a central part 340 of this article list screen. The central part 340 of FIG. 3(b) displays information about three articles, but the number of articles displayed in the central part 340 is not limited to three. The number and layout of articles displayed in the central part 340 are determined for each category in advance by the publisher of the newspaper. In the case where displaying all articles of one category in the central part 340 is not possible, headlines 330 of the rest of the articles may be placed, for example, on the right-hand side of the screen. Selecting an article in the central part 340 or one of the remainder article headlines 330 causes a transition to an individual article screen (FIG. 3(c)) where details of the selected article are displayed.

The date information 310 is information for specifying the date of an article to be displayed. The date information 310 in the illustrated example is a week's worth of dates displayed side by side at the top of the screen. It is preferred to display the date information 310 in this manner, where a given number of days (e.g., seven days) counted back from the latest date among already obtained pieces of newspaper article data are displayed at the same time. FIG. 3(b) illustrates an example in which the latest date among already obtained pieces of newspaper article data is Saturday, July 9. This screen configuration allows the user to specify a desired date from among a plurality of dates with ease. When the user specifies a date, the terminal displays articles of the specified date that belong to the same category as that of the currently displayed article or a similar category as described later. Older date information that precedes the currently displayed dates may be displayed with the user's action in which a finger or the like is slid horizontally over the area where the date information 310 is displayed (dragging on the touch screen). Alternatively, the terminal may be configured to display a button for displaying older date information so that date information older by, for example, a week is displayed each time the button is tapped. In FIG. 3(b), information of the given number of days is displayed with the latest date, “7/9 (Sat.)”, set up on the right edge of the top of the screen. Instead, information of the given number of days may be displayed with the latest date set up on the left edge of the top of the screen.

The category information 320 is information for specifying the category of an article to be displayed. The category information 320 in the illustrated example is categories displayed on top of one another on the left-hand side of the screen. The categories correspond to pages of a newspaper on a one-on-one basis. For example, the front page of a newspaper corresponds to a “first thing in the morning” category, and the first page of the sports section corresponds to a “sports 1” category. The terminal in this embodiment is set to display list information of the “first thing in the morning” category immediately after the application is activated. The category information 320 allows the user to specify a desired category from among a plurality of categories with ease. When the user specifies a category, the terminal displays articles belonging to the specified category that have the same date as that of the currently displayed article. In the case where there are too many categories to contain the entire category information 320 in one screen, the screen may be scrolled vertically to display out-of-view categories.

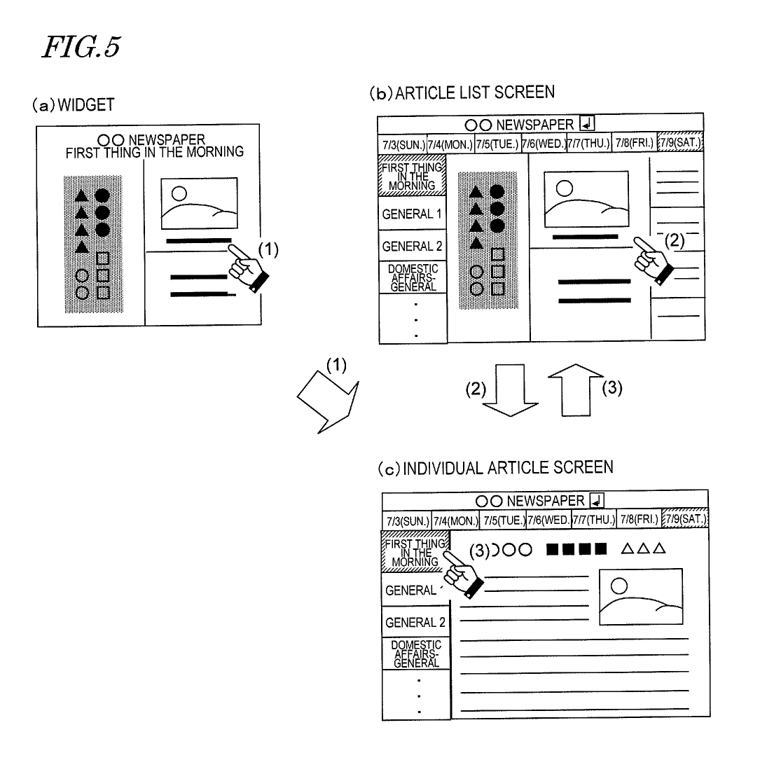

An example of information displayed as the category information 320 is described. FIG. 4 is a diagram illustrating an example of information that is displayed as the category information 320. Words written in a category field of a table illustrated in FIG. 4, such as “first thing in the morning” and “general”, are displayed as the category information 320 on the screen. In the example of FIG. 4, categories are classified into a plurality of groups so that related categories belong to the same group. The processor 140 keeps information as the one illustrated in FIG. 4 in the memory to display the category information 320 on the display 114 based on this information. The processor 140 can also determine the similarity among a plurality of categories based on the classification of FIG. 4 as described later.

The processor 140 thus displays the article list screen in which the display 114 displays, along with the date information 310 including a plurality of dates and the category information 320 including a plurality of categories, list information of a list of contents that belong to a date and category specified by the user from among the dates of the date information and the categories of the category information. When a date different from the date of the currently displayed contents is selected, the display 114 displays list information about a list of contents of the selected date that belong to the same category as that of the currently displayed contents or a similar category. When a category different from the category of the currently displayed contents is selected, on the other hand, the display 114 displays list information about a list of contents belonging to the selected category that have the same date as that of the currently displayed contents. The user can have the thus configured terminal display list information about a list of articles of a desired date and category.

FIG. 3(c) illustrates an example of a screen that is displayed when one of articles displayed by the widget is selected or one of articles displayed in the article list screen is selected. This screen displays details of the selected article, and is called herein as “individual article screen”. The individual article screen, too, displays the date information 310 and the category information 320 so that an article of a date and category selected by the user is displayed. In the case where an article is not contained in one screen, the individual article screen can be scrolled by dragging the screen up and down. In the case where a displayed category has a plurality of articles, the individual article screen can display preceding and following articles that belong to the same date and the same category by dragging the screen to the left and the right. In the individual article screen, an enlarged photograph may be displayed by tapping a part of a photograph that is put alongside the article.

The processor 140 displays the individual article screen in which the display 114 displays, along with the date information 310 including a plurality of dates and the category information 320 including a plurality of categories, details information of contents that belong to a date and category specified by the user from among the dates of the date information and the categories of the category information. When a date different from the date of the currently displayed contents is selected, the display 114 displays list information about a list of contents of the selected date that belong to the same category as that of the currently displayed contents or a similar category. When a category different from the category of the currently displayed contents is selected, the display 114 displays list information about a list of contents belonging to the selected category that have the same date as that of the currently displayed contents. The user can have the thus configured terminal display list information about a list of articles of a desired date and category. When the date or the category is changed in the individual article screen, the display 114 may display the individual article screen of the changed date or category instead of displaying list information that has the changed date or category.

Information displayed in the article list screen and the individual article screen can be enlarged or reduced by the user's action in which the user stretches or shrinks a display area with two fingers (pinching on the touch screen).

The layout of the date information 310 and the category information 320 may differ from the one in the examples of FIGS. 3(a) to 3(c). For example, dates of the date information 310 may be displayed on top of one another whereas categories of the category information 320 may be displayed side by side. Alternatively, the date information 310 and the category information 320 may be arranged horizontally or vertically parallel to each other.

The examples of FIGS. 3(a) to 3(c) show screen images of the information processing terminal 100 that is in a horizontal display mode. The layouts of these screens may be changed when the information processing terminal 100 is tilted by, for example, 90 degrees and set in a vertical display mode. For instance, the date information 310 and the category information 320 in the vertical display mode may be arranged on top of each other at the top of the screen with dates placed side by side and categories placed side by side, or may be arranged next to each other on the left-hand side of the screen with dates placed on top of one another and categories placed on top of one another.

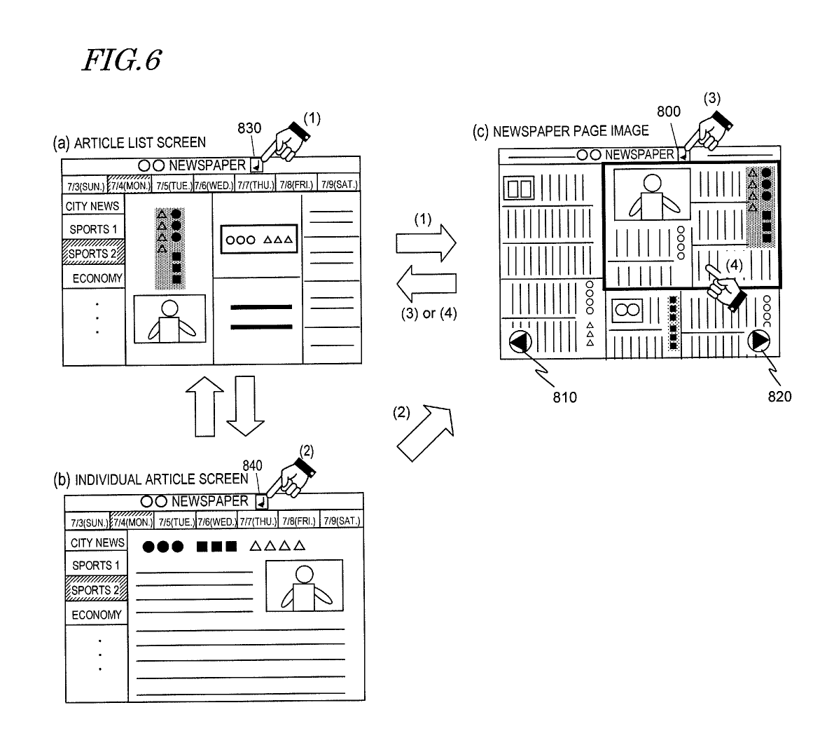

FIGS. 5(a) to 5(c) are diagrams illustrating an example of a method of transition between these screens. Tapping inside the compartment of a specific article that is displayed by the widget of FIG. 5(a) causes the terminal to display the individual article screen of FIG. 5(c) in which details of this article are displayed ((1) in FIGS. 5(a) to 5(c)). Similarly, tapping the compartment of a specific article in the article list screen of FIG. 5(b) causes a transition to the individual article screen of this article ((2) in FIGS. 5(a) to 5(c)). When a specific category is selected in the individual article screen, on the other hand, the terminal shifts to the article list screen of this category ((3) in FIGS. 5(a) to 5(c)). The terminal in this embodiment shifts to the article list screen of a category selected in the individual article screen, irrespective of whether the selected category is the same as or differs from the category of the currently displayed article.

The operation of displaying a details screen of a specific article by tapping inside the compartment of the article in the widget-based screen and the article list screen is implemented by, for example, the following mechanism. The information processing terminal 100 keeps “article area information” indicating which area of the touch screen 110 is associated with which article in, for example, the memory 150. The processor 140 recognizes which point on the touch screen 110 has been tapped by the user, identifies an article that is associated with the tapped point by referring to the article area information, and displays the details screen of the identified article.

An operation of displaying a newspaper image is described next. The information processing terminal 100 in this embodiment is capable of displaying articles in exactly the same layout as that of an actual newspaper, aside from the article list screen and individual article screen described above. A screen displayed in the same layout as that of an actual newspaper may herein be called as “newspaper page image”.

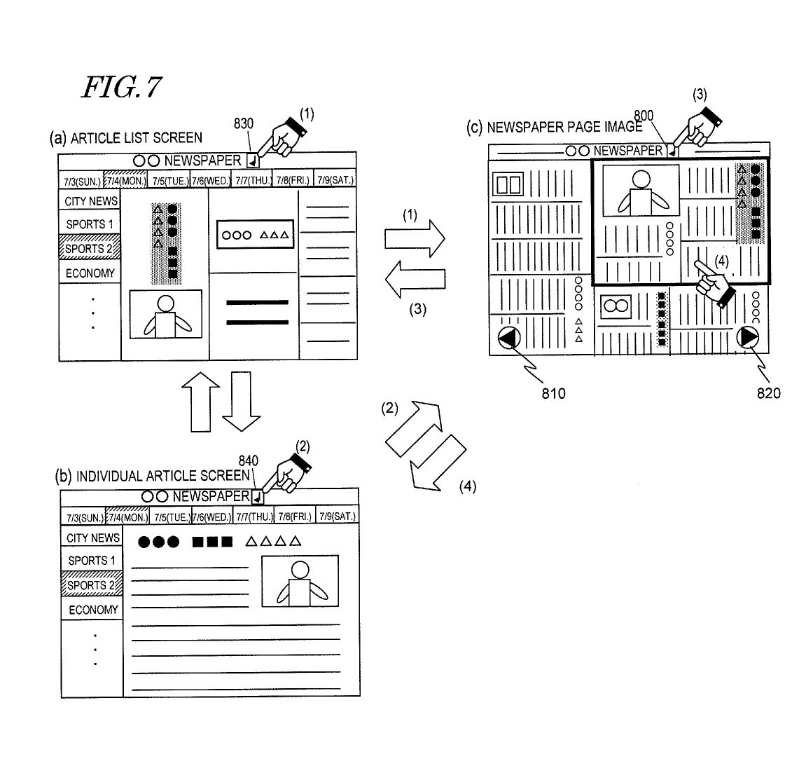

FIGS. 6(a) to 6(c) are diagrams illustrating an example of the operation of displaying a newspaper page image. The article list screen of FIG. 6(a) and the individual article screen of FIG. 6(b) respectively have a newspaper page image display button 830 and a newspaper page image display button 840 at the top of the screens. Tapping the newspaper page image display button 830 or 840 causes the terminal to display a newspaper page image corresponding to an article that has just been displayed as illustrated in FIG. 6(c) ((1) and (2) in FIGS. 6(a) to 6(c)). Alternatively, the terminal may be configured to shift to a newspaper page image when “oo newspaper” displayed in the article list screen and the individual article screen at the top of the screens is tapped instead of the newspaper page image display button 830 or 840.

In this embodiment, where categories and newspaper pages correspond to each other on a one-to-one basis, the newspaper page image of a page corresponding to a category that has just been displayed is displayed. The user can freely scroll and enlarge/reduce the newspaper page image screen as is the case for the individual article screen and other screens. Tapping page switching buttons 810 and 820 of FIG. 6(c) causes the screen to shift page by page.

A converse transition from a newspaper page image to the article list screen is also possible. For example, the newspaper page image screen of FIG. 6(c) has an article list screen display button 800, which is tapped to cause a transition to the article list screen that corresponds to the displayed page ((3) in FIGS. 6(a) to 6(c)). Instead of displaying the button 800, the terminal may assign an equivalent function to one of the operation buttons 120 of FIG. 1. In this example, tapping an area in a newspaper page image where an article is put also causes a transition to the article list screen of the article ((4) in FIGS. 6(a) to 6(c)).

The transition between the article list screen and the individual article screen is executed by the screen switching method described above with reference to FIGS. 5(a) to 5(c).

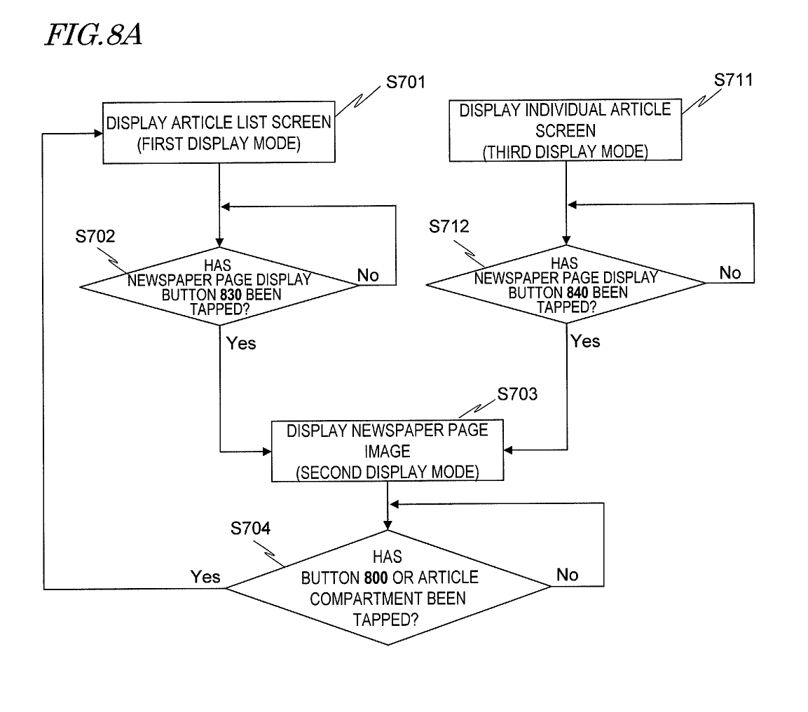

FIGS. 7(a) to 7(c) are diagrams illustrating another example of the operation of displaying a newspaper page image. In the example of FIGS. 7(a) to 7(c), tapping the button 800 which is displayed in the newspaper page image screen of FIG. 7(c) at the top of the screen causes a transition to the article list screen corresponding to the displayed page ((3) in FIGS. 7(a) to 7(c)). Tapping an area in a newspaper page image where an article is put, on the other hand, causes a transition to the individual article screen of the article ((4) in FIGS. 7(a) to 7(c)). The example of FIGS. 7(a) to 7(c) in which the user can specify an article he/she wishes to view in a newspaper page image to cause a direct transition to the details screen of the article is more convenient than the example of FIGS. 6(a) to 6(c).

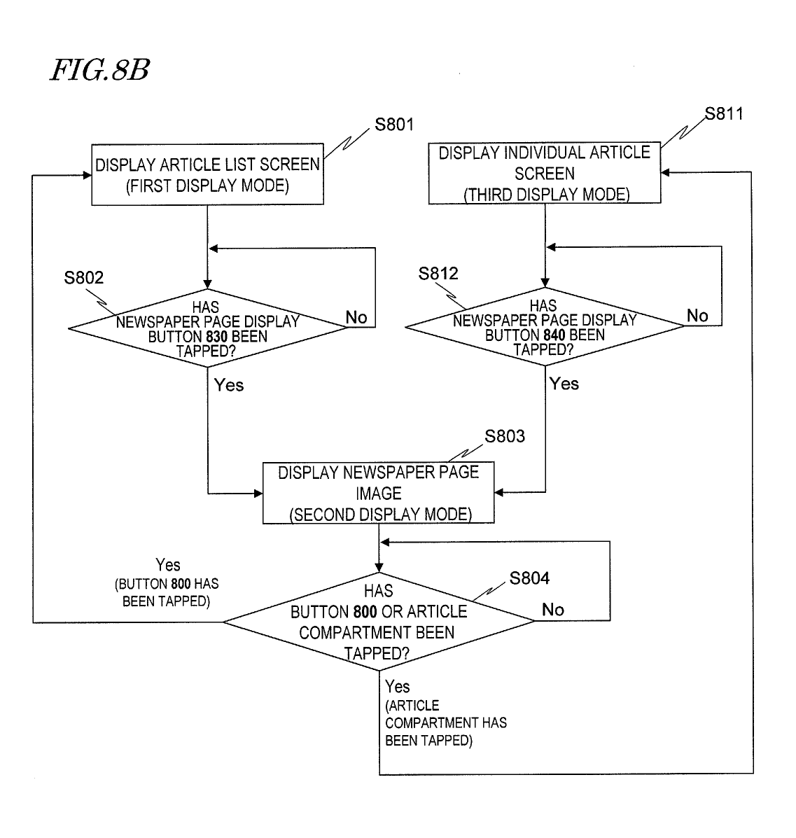

FIGS. 8A and 8B are flow charts illustrating respectively examples of processing steps that are executed by the processor 140 to implement the screen transition operation of FIGS. 6(a) to 6(c) and the screen transition operation of FIGS. 7(a) to 7(c). In the following description, modes in which the processor 140 displays the article list screen, a newspaper page image, and the individual article screen may be referred to as “first display mode”, “second display mode”, and “third display mode”, respectively.

In the example of FIG. 8A, when the article list screen is displayed in Step S701 and then a tap on the newspaper page image display button 830 is detected in Step S702, the processor 140 displays a newspaper page image on the display 114 in Step S703. When the individual article list screen is displayed in Step S711 and then a tap on the newspaper page image display button 840 is detected in Step S712, the processor 140 displays a newspaper page image on the display 114 in Step S703. When a tap on the button 800 or on the compartment of a specific article is detected in Step S704 while the terminal is in the second display mode where a newspaper page image is displayed, the processor 140 moves to Step S701 and switches to the first display mode to display the article list screen.

In the example of FIG. 8B, Steps S801 to S803 and S811 and S812 are respectively the same as Steps S701 to S703 and S711 and S712 of FIG. 8A, but Step S804 differs from Step S704. When a tap on the button 800 is detected in Step S804, the processor 140 switches to the first display mode to display the article list screen (Step S801). When a tap on the compartment of an article is detected in Step S804, on the other hand, the processor 140 switches to the third display mode to display a details screen of the article on the display 114 (Step S811).

The terminal in the example described above can shift to a newspaper page image from the article list screen and from the individual article screen both. However, it is sufficient if the terminal is capable of at least screen transition between the article list screen and the newspaper page image.

A newspaper page image has exactly the same information as that of a page of a newspaper delivered to home or sold in stores. The individual article screen may not hold all pieces of information of a newspaper due to the configuration of the screen. The article list screen is useful in that the user can quickly grasp list information about a list of articles that are considered important by the publisher of the newspaper. However some user may want to search for information he/she wishes to read from an actual newspaper. In such cases, the user can read all pieces of information and search for desired information by referring to a newspaper page image.

Conventional information processing terminals that display newspaper articles are supposed to display only one of a screen for displaying a newspaper page image and a screen for displaying a list or articles that are considered important by the publisher of the newspaper. The conventional terminals therefore cannot deal with the case where the preferred screen display mode varies from one user to another and the case where the same user wishes to switch to a different screen display mode that suits the situation.

In other words, some users prefer one of the two types of screens described above, but a conventional device that provides only one of the screens cannot fulfill this need. For the newspaper industry where the number of users is large, the advantage of letting a user select a preferred screen as in this embodiment is great.

In addition, the same user may want to absorb a page on the newspaper page image screen by analyzing the intention of the publisher before reading detailed articles in the case where the user has time or the like, and want to read only main articles on the article list screen in the case where the user has little time. Conventional devices cannot switch between the newspaper page image screen and the screen for displaying a list of articles that are considered important by the publisher with a simple operation, and significantly impair the convenience of users.

Those problems are not limited to the newspaper industry and are also observed in the book industry which publishes magazines and general articles. This embodiment solves those problems and thus improves users' convenience markedly.

An example of a method of constructing the article list screen is described next.

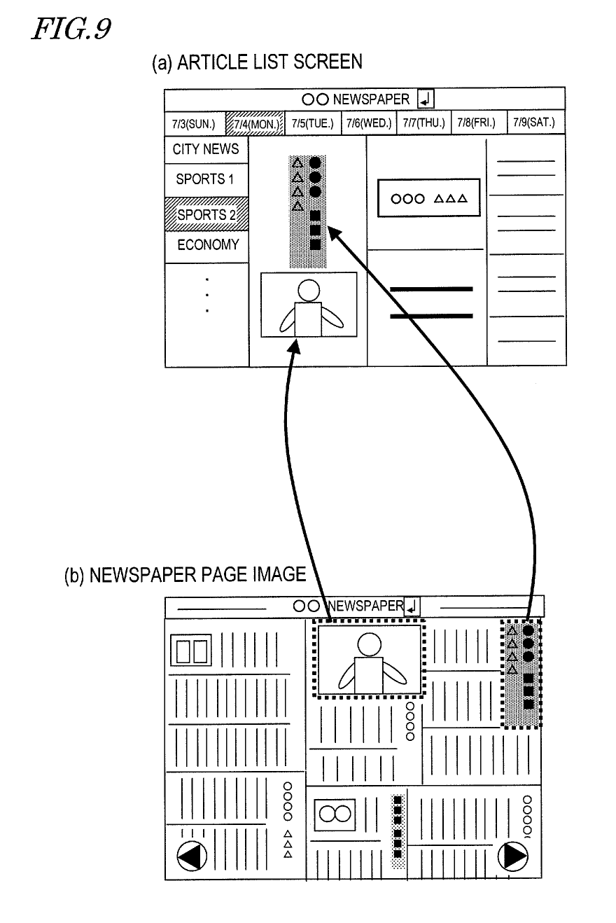

FIG. 9 are diagrams illustrating an example of the relation between information that is displayed in the article list screen and information of a newspaper image in this embodiment. As illustrated in the figures, a part of an article in a newspaper page image can be used as it is as information of the article displayed in the article list screen. The headline and/or photograph of the article is typically used. Instead of simply displaying a headline in a normal font, the article list screen can thus display a headline in exactly the same image as that of the impactful headline on the newspaper page. This makes the article list screen impactful. The article list screen may display text in a normal font.

The layout of the article list screen is determined by, for example, the publisher of the newspaper articles with the use of a dedicated tool (called “authoring tool”). An authoring tool is a program for automatically generating candidate layouts of the article list screen based on newspaper article data that is prepared in a predetermined format. After all articles have been created, the publisher of the newspaper articles inputs article data to the authoring tool to obtain candidate layouts of the article list screen. The publisher can choose one optimum layout from the plurality of automatically generated candidates. The publisher may also modify the layout himself/herself.

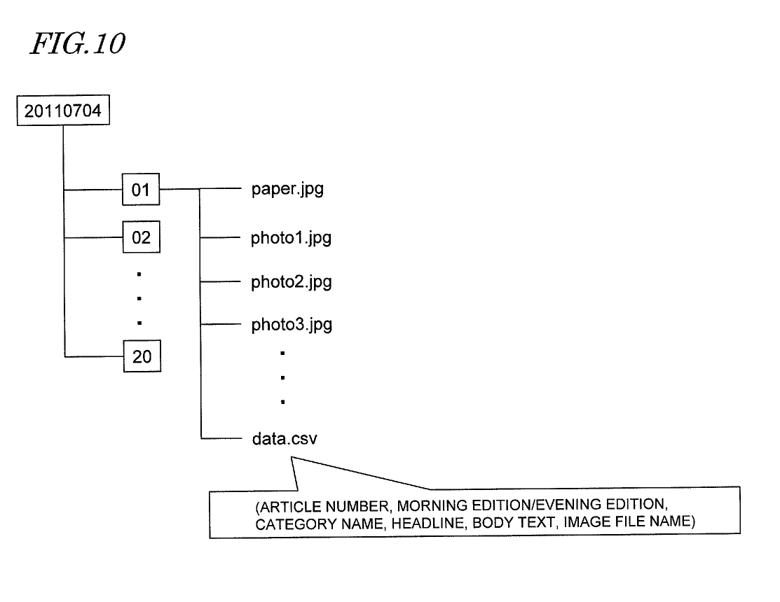

FIG. 10 is a diagram illustrating an example of the data structure of article data that is input to an authoring tool. The publisher of the newspaper finishes creating data that has the illustrated structure before distribution. In FIG. 10, letters enclosed in a rectangle represent a directory (or a folder), and letters that are not enclosed in a rectangle represent a file. In the case where the distribution date is Jul. 4, 2011, the article data is stored under a directory “20110704”.

The “20110704” directory includes directories “01” to “20” which respectively correspond to pages (categories) of the newspaper. Specifically, the “01” directory stores data relevant to the front page and the “20” directory stores data relevant to the twentieth page (the last page). The directories “01” to “20” each include “paper.jpg” which is image data of the entire page, “photo1.jpg”, “photo2.jpg” . . . which are pieces of image data of individual articles, and “data.csv” which is data describing details information of articles of that page. The data “data.csv” of each page which describes details information of articles of the page has, for each article included in that category, information such as an article number, a morning edition/evening edition flag, a category name, a headline, the body text, and an associated image file name. Image files in the illustrated example are Joint Photographic Experts Group (JPEG) files but other image file formats may be used. Similarly, data describing details information of articles of each page is not limited to a Comma Separated Values (CSV) file and other file formats may be used. FIG. 10 illustrates only files under the directory “01” and omits files under other directories.

The authoring tool reads data whose exemplary structure is illustrated in FIG. 10 and generates candidate layouts of the article list screen for each category based on data that is written in data.csv. A candidate layout is generated by, for example, a method in which the importance of each article is calculated based on a given standard, some of articles that are considered to be of high importance are arranged in the central part 340, and only text headlines of the rest of the articles are displayed as the remainder article headlines 330. The plurality of generated candidates is further scored from various viewpoints and the layout that has the highest score is selected.

The authoring tool has a graphical user interface to enable the publisher of the newspaper to modify a selected layout. The publisher of the newspaper can thus edit the article list screen in a manner that makes the screen more impactful. For example, the publisher may change an article to be displayed large in the article list screen or may change the sizes of the compartments of the respective articles. The publisher may also edit the article list screen so that a partial headline, partial photograph, or the like of one article in a newspaper page image is displayed in the article list screen by cut and paste as illustrated in FIGS. 9(a) and 9(b).

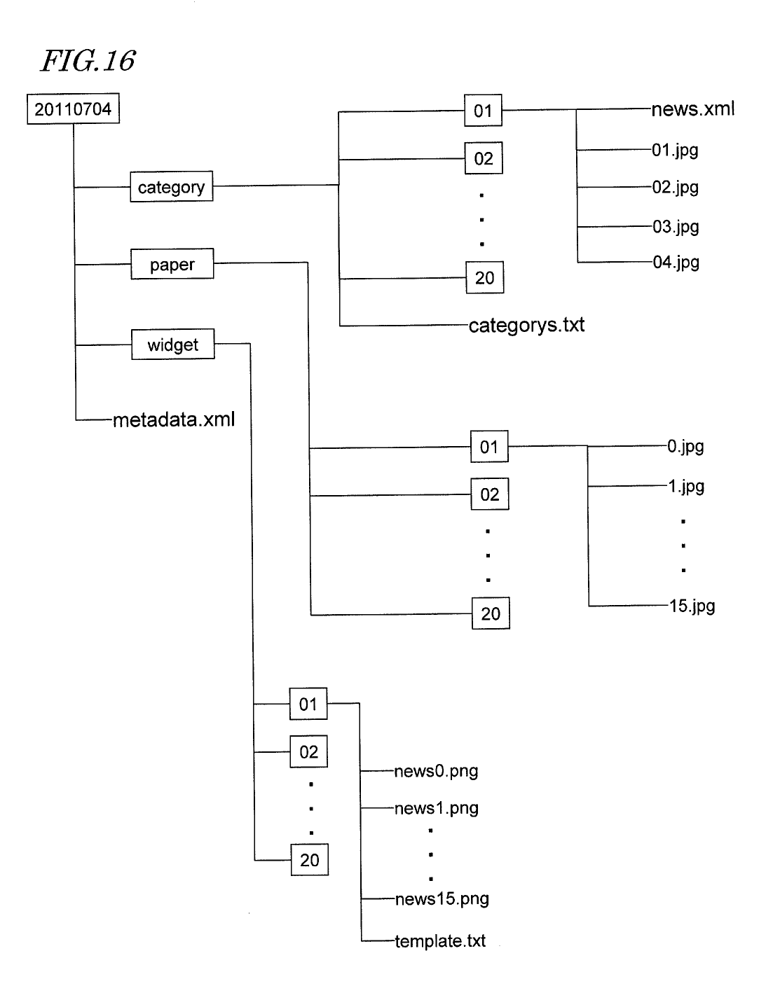

When the publisher of the newspaper performs processing of completing the article list screen layout creation, the authoring tool outputs data to be distributed to each user (distributed data). The distributed data is distributed to the information processing terminal 100 of each user via a telecommunication line. Details of the distributed data are described later with reference to FIG. 16.

Other functions of the information processing terminal 100 of this embodiment are described next. The information processing terminal 100 may include, in addition to the operations described above, the following functions.

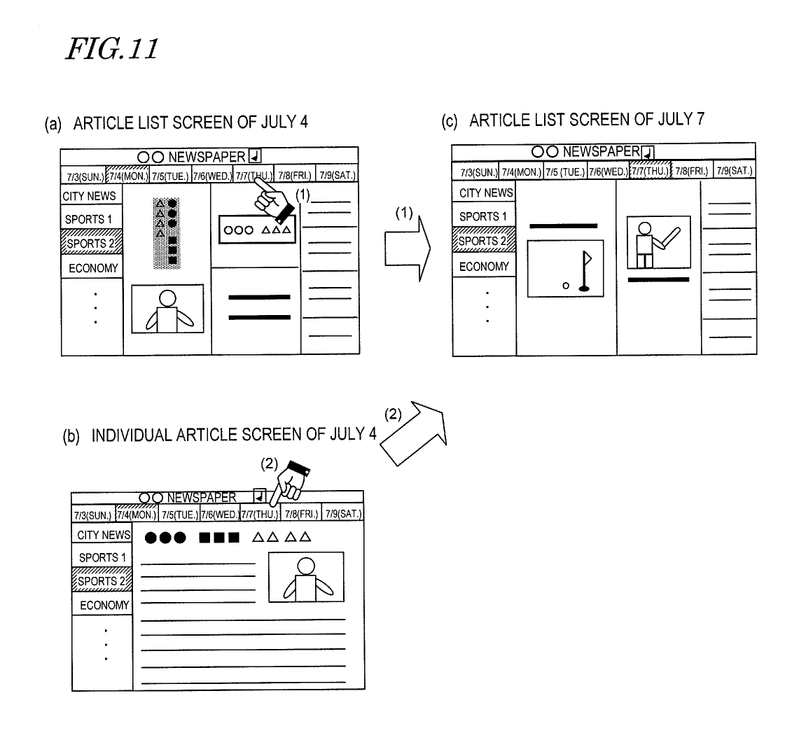

FIGS. 11(a) to 11(c) are diagrams illustrating an example of screen transition that takes place when the user changes the date while the article list screen or the individual article screen is displayed. First, as illustrated in FIG. 11(a), the article list screen of a “sports 2” category for Monday, July 4, is displayed. In this state, the user taps a part of the date information where “7/7 (Thu.)” is displayed, causing a transition to the article list screen of FIG. 11(c) which is of the “sports 2” category for Thursday, July 7 ((1) in FIGS. 11(a) to 11(c)). The terminal shifts to the screen of FIG. 11(c) also when the user taps a part of the date information where “7/7 (Thu.)” is displayed while viewing the individual article screen of the “sports 2” category for Monday, July 4, as illustrated in FIG. 11(b) ((2) in FIGS. 11(a) to 11(c)).

Thus, when a date different from the date of the currently displayed article is specified, the article list screen of the same category for the specified date is displayed. There may be cases where articles of the same category do not have the specified date. For instance, the currently displayed “sports 2” category may include no articles of the specified date. In such cases, when a category similar to “sports 2” includes articles of the specified date, the article list screen of this category is displayed. For example, when the “sports 2” category includes no articles of the specified date, the article list screen of “sports” is displayed instead. Similar categories are, for example, “sports” and “sports 2”, and “general 1” and “general 2”. When there is no category similar to the category of the currently displayed article, the initial screen which is set in advance (for example, the front page) is displayed.

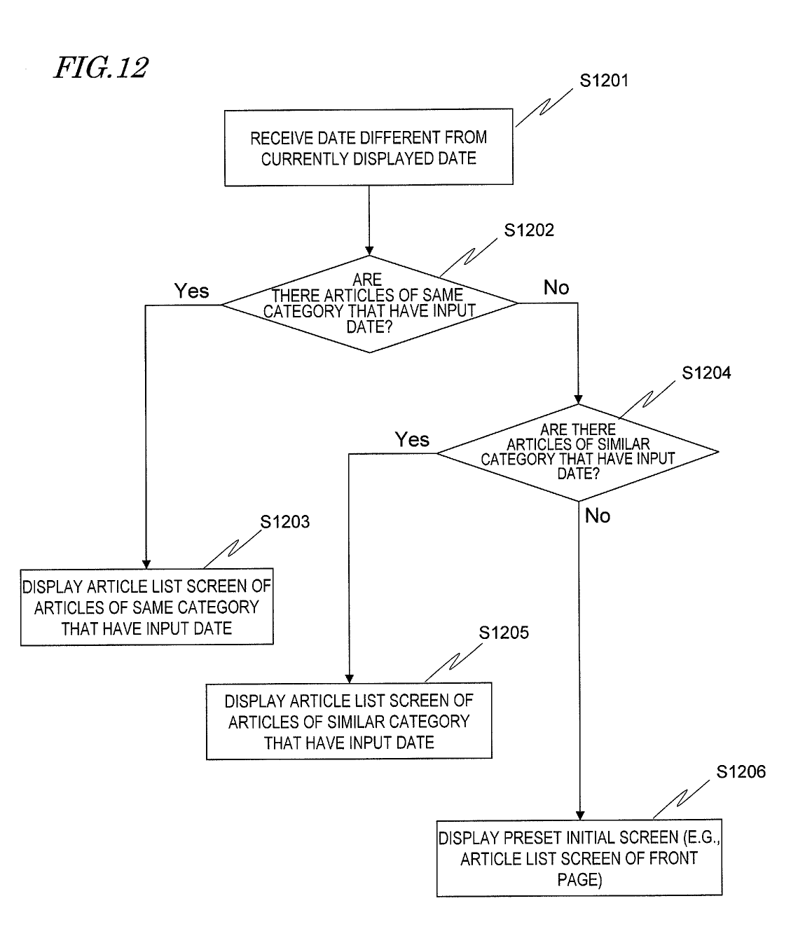

FIG. 12 is a flow chart illustrating the flow of processing that is executed by the information processing terminal 100 in order to implement the date changing operation described above. First, an input of a date different from the date of the currently displayed article is received via the touch sensor 112 (Step S1201), and the processor 140 determines whether or not there are articles of the same category as that of the currently displayed article (Step S1202). When there are articles of the same category that have the specified date, the processor 140 displays the article list screen of this category on the display 114 (Step S1203). When there are no articles of the same category that have the specified date, the processor 140 determines whether or not there are articles of a similar category that have the specified date (S1204). When there are articles of a similar category that have the specified date, the processor 140 displays the article list screen of the similar category on the display 114 (Step S1205). When there are not even articles of a similar category that have the specified date, the processor 140 displays the initial screen set in advance (for example, the article list screen of the front page) on the display 114.

How the presence or absence of articles of a similar category is determined is described next. For example, the information processing terminal 100 can determine as a similar category a category that is found through a prefix search to have a name partially overlapping with the current category name. Alternatively, the terminal may determine similarity based on a table that defines preset similar categories as the one illustrated in FIG. 4. The information processing terminal 100 holds the information of FIG. 4 in the memory 150 in the form of a table, and the processor 140 refers to this table to determine similarity. For example, in the case where the currently displayed article is an article of an “international-general” category and there are no articles of the “international-general” category that have the specified date, articles of a “general” category which belongs to the same “general” group and which is at the top of the group are displayed when there are any on the specified date. The information processing terminal 100 may skip the determination of similarity to display the preset initial screen immediately when there are no articles of the same category.

As described, when a date different from the date of the currently displayed contents is selected, the information processing terminal 100 of this embodiment displays contents of the same category as that of the currently referred contents or a similar category. According to this embodiment, when the date is changed, contents highly related to those that have just been viewed can be viewed successively without needing to shift to the initial screen, and users' convenience is thus improved compared to conventional information processing terminals.

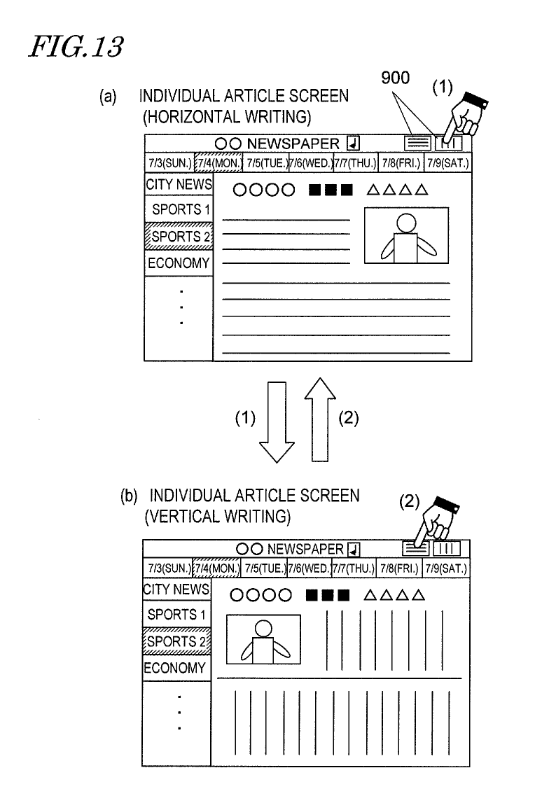

FIGS. 13(a) and 13(b) are diagrams illustrating a function of switching between a horizontal writing display mode and a vertical writing display mode. As illustrated in the drawings, the information processing terminal 100 may have a function of switching the display mode of the individual article screen between horizontal writing display and vertical writing display. A newspaper in Japanese is usually written vertically, and a need for vertically written Japanese articles to read on the information processing terminal 100 is expected. Display switching buttons 900 for switching between horizontal writing and vertical writing may therefore be provided in the individual article screen as illustrated in FIG. 13(a). Tapping the display switching buttons 900 allows conversion from horizontal writing to vertical writing ((1) in FIGS. 13(a) to 13(c)) and conversion from vertical writing to horizontal writing ((2) in FIGS. 13(a) to 13(c)).

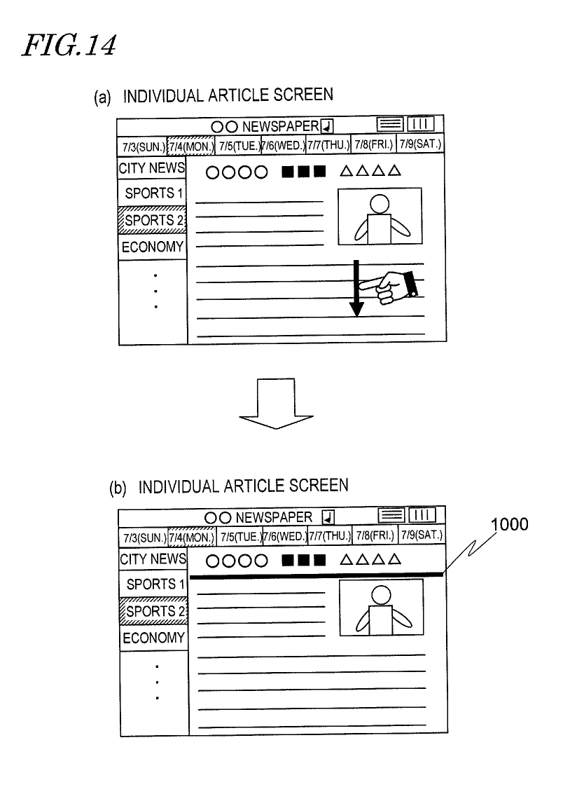

FIGS. 14(a) and 14(b) are diagrams illustrating an example of an operation of displaying an alert about the fact that the individual article screen cannot be scrolled further. The individual article screen cannot be scrolled further after the end of an article is reached. At that point, the information processing terminal 100 displays a red line (alert display) 1000 in order to inform the user of the fact that the end of the article has been reached. This function calls the user's attention to an unintended scrolling action due to a slip of a finger that occurs when, for example, the user is trying to display an enlarged view of a photograph in the article by tapping the photograph. The alert display which is a red line in this embodiment can be any display form as long as the user's attention can be drawn.

An example of data distribution to the information processing terminal 100 and distributed data is described next.

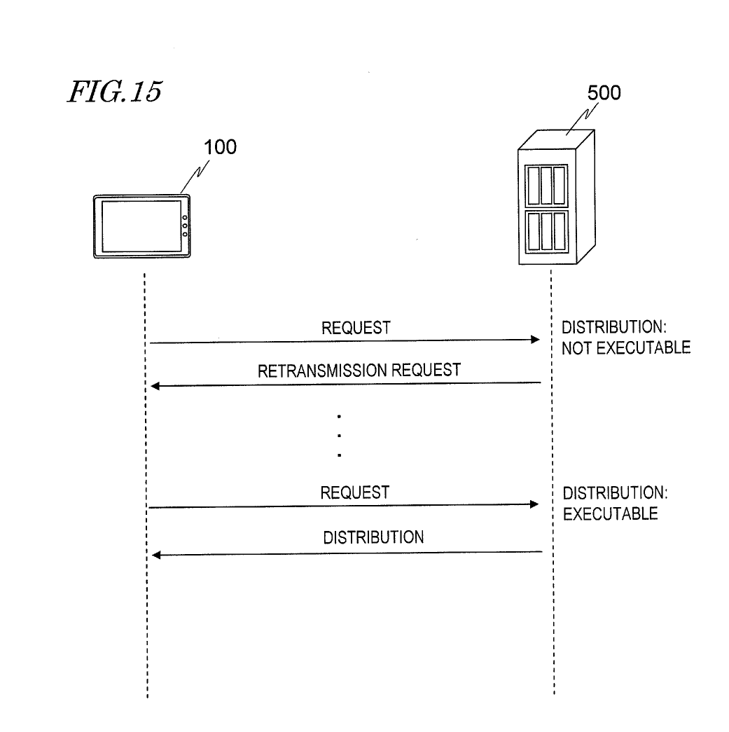

FIG. 15 is a diagram illustrating an example of information communication between the information processing terminal 100 and the distribution server 500 of a newspaper publishing company which is provided on a site remote from the terminal. The information processing terminal 100 in this embodiment obtains newspaper article data every morning from the distribution server 500 placed on a site remote from the terminal. In the illustrated example, the information processing terminal 100 requests distribution from the distribution server 500 every morning at a fixed time (for example, 5 a.m.). The distribution server 500 distributes article data of the day in response to the request. However, depending on the processing performance of the distribution server 500, a limit to transmission traffic volume, and other factors, the distribution server 500 may be unable to distribute data when many requests arrive at the same time or the like. In such cases, the distribution server 500 notifies the information processing terminal 100 to request again after waiting for a given period of time (a retransmission request). Receiving the retransmission request, the information processing terminal 100 waits for a given period of time (five minutes, for example) and then requests distribution again. The distribution server 500 receives the request and, after determining that distribution is possible, distributes article data to the information processing terminal 100.

FIG. 16 is a diagram illustrating an example of the data structure of article data which is distributed to the information processing terminal 100. The illustrated data is generated by the authoring tool described with reference to FIG. 10. The information processing terminal 100 receives data that has the illustrated data structure from the distribution server 500 every morning. In FIG. 16, letters enclosed in a rectangle represent a directory (or a folder), and letters that are not enclosed in a rectangle represent a file. In the case where the distribution date is Jul. 4, 2011, the article data is stored under a directory “20110704” to be distributed.

The “20110704” directory includes a “category” directory, a “paper” directory, a “widget” directory, and a “metadata.xml” file. The “category” directory stores data of contents displayed in the article list screen and the individual article screen. The “paper” directory stores image data displayed in the newspaper page image screen. The “widget” directory stores image data displayed in the widget-based screen. The “category” directory, the “paper” directory, and the “widget” directory each include directories “01” to “20”, which correspond to respective pages (categories) of the newspaper. Specifically, the “01” directory stores data relevant to the front page and the “20” directory stores data relevant to the 20th page (the last page). The file “metadata.xml” is an Extensible Markup Language (XML) file that describes metadata such as date.

The “category” directory includes “categorys.txt” which describes a list of category names. The information processing terminal 100 refers to this data to display category information in the article list screen and the individual article screen. The directories “01” to “20” that are included in the “category” directory each include a “news.xml” file and a plurality of Joint Photographic Experts Group (JPEG) files. The “news.xml” file is an XML file that describes text data of every article belonging to the category in question, paths to image data (the JPEG files described above), and article layout information. The processor 140 refers to this XML file to display respective articles on the display 114. FIG. 16 omits files under directories other than the “01” directory.

For each page of a newspaper, data of a newspaper page image is broken into 16 pieces, which are stored in the “paper” directory. The directories “01” to “20” each store 16 JPEG files. These JPEG files are obtained by breaking newspaper paper image into 16 images, which together constitute one page of newspaper image. The processor 140 receives from the user a request to display a newspaper page image, and then uses these JPEG files to display the newspaper page image screen. FIG. 16 omits files under directories other than the “01” directory.

The “widget” directory stores data for defining the compartments of images displayed in the widget-based screen and the article list screen. The directories “01” to “20” each store 16 Portable Network Graphics (PNG) files and a “template.text” file. The “template.text” file describes compartment information for defining the compartments of respective articles in the widget-based screen and the article list screen. The compartment information is used as the “article area information” described above. Files “news0.png” to “news15.png” are pieces of data obtained by dividing an image that is displayed in the widget-based screen and the article list screen into 16 images by category. The compartment information indicates which part of the screen divided equally into 16 parts and represented by these pieces of data is associated with which article. The “article area information” is not limited to this example, and may be information indicating which coordinates on the screen are associated with which article. For instance, in the case where a point on the screen is expressed by rectangle coordinates, the “widget” directory may record a file defining which coordinates are associated with which article, instead of the above-mentioned compartment information. In addition to the data described above, the “widget” directory may store advertisement image data and the like.

The distributed data described above allows the information processing terminal 100 to display latest article data. The information processing terminal 100 receives every morning distributed data whose exemplary data structure is illustrated in FIG. 16 and stores the data in the memory 150. The processor 140 reads data received that day out of the memory 150 to construct the widget-based screen, the article list screen, the individual article screen, and the newspaper page image screen, and displays the screens on the display 114. The data structure of FIG. 16 is merely an example, and the distributed data can have any data structure as long as the operations in this embodiment can be implemented. The description given above is about an example in which morning edition data is distributed, but the distributed data may be data of an evening edition or an extra issue.

As described above, the information processing terminal 100 of this embodiment displays contents based on newspaper article data which is distributed from the distribution server 500 of a newspaper publishing company. However, the present invention is not limited to this mode. For example, the displayed contents are not limited to newspaper articles, but may be magazine and general book contents as long as the contents are data supplied as print on paper and provided electronically as well. Contents data may be recorded in the information processing terminal 100 via a recording medium instead of a telecommunication line.

Programs that define the above-mentioned processing procedures which are executed by the processor 140 in this embodiment can be distributed independently of the information processing terminal 100. These programs can be recorded in the information processing terminal 100 via, for example, a telecommunication line or via a recording medium such as a CD-ROM, a DVD-ROM, a magnetic tape, or a memory card.

The operating system (OS) of the information processing terminal 100 in this embodiment is not limited to a particular OS and may be, for example, one of Android (registered trademark), iOS (registered trademark), and Windows (registered trademark), or other OSs. The information processing terminal 100 may be a tablet terminal or may be a so-called smart phone. A terminal that does not have the functions of this embodiment can function as the information processing terminal 100 of this embodiment if programs (applications) that define the processing procedures of this embodiment are downloaded from, for example, a site selling programs and installed in the terminal.

In the embodiment described above, contents displayed in the article list screen and the individual article screen are sorted by the date information 310 and the category information 320 as illustrated in FIGS. 3(a) to 3(c). The present invention, however, does not need to take this mode. For example, the screens may each be configured so that a date and/or a category can be specified with the use of a text box or pull-down menus. Furthermore, each of the functions in the embodiment described above is an option that can be chosen or rejected freely. The information processing terminal according to this embodiment is not limited to the embodiment described above, and can have any configuration as long as the terminal can switch between the first mode for displaying list information of contents and the second mode for displaying contents in the same layout as the actual layout of the contents supplied as print on paper.

### INDUSTRIAL APPLICABILITY

The present invention is applicable to uses where contents supplied as print on paper and provided electronically as well are displayed. For example, the present invention is useful for devices that display electronically provided articles of newspapers, magazines, and general books.

### REFERENCE SIGNS LIST

100 information processing terminal
110 touch screen
112 touch sensor
114 display
120 operation button
140 processor
150 memory
160 communication circuit
180 acceleration sensor
200 bus
310 date information
320 category information
330 headline
340 central part
500 distribution server
800 article list screen display button
810, 820 page switching button
830, 840 newspaper page image display button
900 display switching button
1000 alert display

1. An information processing terminal for displaying contents that are supplied as print on paper and provided electronically as well, the information processing terminal comprising:
a display;
a touch sensor configured to detect an input from a user on the display; and
a control unit configured to display the contents on the display and having a first display mode for displaying list information of the contents on the display, a second display mode for displaying the contents on the display in the same layout as a layout of the print on paper, and a third display mode for displaying details information of the contents on the display, the control unit being capable of switching the first display mode to the second display mode or the third display mode in accordance with an instruction from the user, switching the second display mode to the first display mode in accordance with an instruction from the user, and switching the third display mode to the first display mode or the second display mode in accordance with an instruction from the user.

2. The information processing terminal according to claim 1, wherein the contents are newspaper articles.

3. The information processing terminal according to claim 1, wherein the control unit selects a portion of the contents displayed in the second display mode and displays the portion in the first display mode as well on the display.

4. The information processing terminal according to claim 3, wherein the portion of the contents is an image that represents a headline of an article or a photograph.

5. The information processing terminal according to claim 1, wherein the control unit displays a first button for switching to the second display mode on the display in the first display mode, displays a second button for switching to the first display mode on the display in the second display mode and, when the user taps the first button or the second button, switches between the first display mode and the second display mode.

6. The information processing terminal according to claim 1,
wherein, in the first display mode, the contents are sorted by date information and category information, and
wherein, when the user specifies a particular article displayed on the display in the second display mode, the control unit switches to the first display mode to display list information of a date and a category to which the particular article belongs on the display.

7. The information processing terminal according to claim 1, wherein, when the user specifies a particular article in the first display mode, the control unit switches to the third display mode.

8. The information processing terminal according to claim 1, wherein, when the user specifies a particular article displayed on the display in the second display mode, the control unit switches to the third display mode.

9. The information processing terminal according to claim 1, wherein, in the third display mode, the control unit displays a third button for switching to the second display mode on the display and, when the user taps the third button, switches to the second display mode.

10. The information processing terminal according to claim 1, wherein, when the user performs pinching in the second display mode, the control unit increases or reduces display magnification.

11. The information processing terminal according to claim 1, wherein, when the user performs dragging in the second display mode, the control unit scrolls display.

12. The information processing terminal according to claim 1,
wherein, in the first display mode, the contents are sorted by date information and category information, and
wherein, in the first display mode, the control unit displays, on the display, the date information including a plurality of dates, the category information including a plurality of categories, and list information about a list of contents belonging to a date and a category that are selected by the user from among the plurality of dates of the date information and the plurality of categories of the category information.

13. The information processing terminal according to claim 12, wherein, when a date different from a date of currently displayed contents is selected in the first display mode, the control unit displays, on the display, list information about a list of contents of the selected date that belong to the same category as a category of the currently displayed contents or a category similar to the category of the currently displayed contents.

14. The information processing terminal according to claim 13, wherein, when a category different from a category of currently displayed contents is selected in the first display mode, the control unit displays, on the display, list information about a list of contents of the selected category that belong to the same date as a date of the currently displayed contents.

15. An information processing terminal for displaying contents that are supplied as print on paper and provided electronically as well, the information processing terminal comprising:
a display;
a touch sensor configured to detect an input from a user on the display;
a memory;
a processor; and
a program stored in the memory and configured to be executed by the processor, the program including the steps of:
displaying list information of the contents on the display;
displaying the contents on the display in the same layout as a layout of the print on paper;
displaying details information of the contents on the display;
switching a first display mode for displaying the list information of the contents on the display to a second display mode for displaying the contents on the display in the same layout as the layout of the print on paper or to a third display mode for displaying the details information of the contents on the display in accordance with an instruction from the user;
switching the second display mode to the first display mode in accordance with an instruction from the user; and
switching the third display mode to the first display mode or the second display mode in accordance with an instruction from the user.

16. A display control method for use in an information processing terminal for displaying contents that are supplied as print on paper and provided electronically as well, the display control method comprising the steps of:
displaying list information of the contents on a display of the information processing terminal;
displaying the contents on the display in the same layout as a layout of the print on paper;
displaying details information of the contents on the display;
switching a first display mode for displaying the list information of the contents on the display to a second display mode for displaying the contents on the display in the same layout as the layout of the print on paper or to a third display mode for displaying the details information of the contents on the display in accordance with an instruction from a user;
switching the second display mode to the first display mode in accordance with an instruction from the user; and
switching the third display mode to the first display mode or the second display mode in accordance with an instruction from the user.

17. A non-transitory computer readable storage medium storing a program to be executed by a computer mounted in an information processing terminal for displaying contents that are supplied as print on paper and provided electronically as well, the program causing the computer to execute the steps of:
displaying list information of the contents on a display of the information processing terminal;
displaying the contents on the display in the same layout as a layout of the print on paper;
displaying details information of the contents on the display;
switching a first display mode for displaying the list information of the contents on the display to a second display mode for displaying the contents on the display in the same layout as the layout of the print on paper or to a third display mode for displaying the details information of the contents on the display in accordance with an instruction from a user;
switching the second display mode to the first display mode in accordance with an instruction from the user; and
switching the third display mode to the first display mode or the second display mode in accordance with an instruction from the user.

18. The information processing terminal according to claim 1, wherein the second display mode is further switchable to the third display mode in accordance with an instruction from the user.
